(19) United States
(12) Patent Application Publication
(10) Pub. No.: US 2003/0172597 A1
(43) Pub. Date: Sep. 18, 2003

(54) Bunker sealing system

(76) Inventor: Gary Folkema, Ingersol (CA)

Correspondence Address: MARK A. KOCH, 866 Main Street East, Hamilton, ON, L8M 1L9, CA

(21) Appl. No.: 10/378,619

(22) Filed: Mar. 5, 2003

Related U.S. Application Data
(60) Provisional application No. 60/363,359, filed on Mar. 12, 2002.

(51) Int. Cl. E04B 1/34; B62D 63/04; E04B 7/00; E02D 27/00; E04H 7/00; E04B 1/00; E04G 21/00; E04G 23/00

(52) U.S. Cl. 52/23; 52/3; 52/192; 52/169.7; 52/741.14

(57) ABSTRACT

The present invention a bunker sealing system for use with a horizontal style bunker, the bunker sealing system includes a bunker silo for storing silage therein, a cover for selectively covering and sealing silage; wherein the cover being comprised of liquid fillable bladders. The bunker sealing system further including cover handling equipment including a spool for spooling and unspooling the cover onto and off of a cover spool such that the penetration of water and air into silage is minimized and further includes a cover carriage for supporting, the spool including wheels cooperatively rolling along top rails mounted on top of bunker walls, such that the carriage spans between two bunker walls and is rollably moveable longitudinally along the walls.

This application claims the benefit of and priority to U.S. Provisional Patent application Serial No. 60/363,359 filed Mar. 12, 2002, the disclosure of which is incorporated herein by reference in its entirety.

### FIELD OF THE INVENTION

The present invention relates to bunker silos, in particular a method and apparatus of sealing bunker silos.

### BACKGROUND OF THE INVENTION

Bunker silos have become the presently preferred method for storing silage. Bunker silos offer the user reasonable capital costs, high storage volumes, quick and easy filling procedures for the storage of silage.

There are however problems which have plagued storage of silage in bunker silos, most of which are as a result of penetration of air, moisture, or rodents into the silage over time. Currently in order to minimize penetration of air and water and rodents into the silage, a plastic cover is placed over the silage after it has been compacted into the bunker silo and normally old tires are then placed on top of the cover to keep it in place during the storage season. As the silage is being consumed at the feeding face, the cover is rolled back as required. The placement of the cover and the tires is a time consuming manual procedure which tends to be very cumbersome. In particular it is impractical to keep the feeding face covered over during inactive intervals. In other words the feeding face is almost always exposed increasing the probability of penetration of water and air into the stored silage.

Therefore there is a need for a silo covering system which provides for rapid covering and uncovering with minimal labour requirements. In addition, there is a need for a covering system which reduces the exposure of the stored silage from penetration of water and air and also which minimizes contamination of the silage from rodents, birds, pets and faeces.

### SUMMARY OF THE INVENTION

A bunker sealing system for use with a horizontal style bunker, said bunker sealing system comprises

a) a bunker silo for storing silage therein;

b) a cover for selectively covering and sealing silage; and

b) a means for selectively covering and sealing silage such that the penetration of water and air into silage is minimized.

Preferably wherein said covering means including a liquid means for selectively filling and removing liquid from said cover for weighing down said cover with liquid thereby ensuring said cover remains on said silage and maximizes sealing of said cover.

Preferably wherein said cover being comprised of liquid fillable bladders.

Preferably wherein said cover being comprised of a moisture barrier sheet and a network of cover tubing attached to said moisture barrier, wherein said tubing for filling and evacuating with liquid for weighing down said cover with liquid thereby ensuring said cover remains on said silage and maximizes sealing of said cover.

Preferably wherein said covering means includes cover handling equipment including a means for spooling and unspooling said cover onto and off of a cover spool.

Preferably wherein said spool means includes a carriage means for moving said spool means longitudinally along the length of the bunker silo and supporting said spool means.

Preferably wherein said carriage means includes a cover carriage includes wheels cooperatively rolling along top rails mounted on top of bunker walls, such that said carriage spans between two bunker walls and is rollably moveable longitudinally along said walls.

Preferably wherein said spool means includes means for raising and lowering said spool.

Preferably wherein said spool means includes rotating means for applying rotational forces to said cover spool for spooling and unspooling.

Preferably wherein said carriage means includes a drive means for moving said carriage longitudinally along said bunker silo.

Preferably wherein said liquid means includes water handling equipment including a manifold for selectively communicating liquid to said cover.

Preferably wherein said liquid means further includes a main storage tank for selectively communicating liquid to said manifold under a head of liquid pressure.

Preferably wherein said liquid means includes a surge tank for receiving liquid from said cover and communicating said liquid back to said storage tank.

Preferably wherein said liquid means includes a liquid pumping system and valves for controlling movement of liquid between the storage tank, manifold and surge tank.

Preferably wherein said spooling means and carriage means cooperates with said liquid means such that filling said cover with liquid aids in unspooling said cover off of said cover spool and simultaneously

### BRIEF DESCRIPTION OF THE DRAWINGS

FIG. 1 is a schematic top plan view of bunker sealing system with the silage uncovered.

FIG. 2 is a schematic cross side elevational view of the bunker sealing system showing the cover carriage positioned in the carriage cradle.

FIG. 3 is a schematic top plan view of the bunker sealing system showing the silage being completely covered over with the cover.

FIG. 4 is a schematic side elevational view of the bunker sealing system together with partial cut away showing the silage completely covered over with the cover.

FIG. 5 is a schematic cross sectional view through the cover shown in FIG. 6.

FIG. 6 is a schematic top plan view of the cover together with the manifold.

FIG. 7 is a schematic side elevational view of the cover together with the manifold.

FIG. 8 is a schematic cross sectional schematic view of the cover shown in FIG. 9.

FIG. 9 is a schematic top plan view of the cover shown together with the manifold.

FIG. 10 is a schematic side elevational view of the cover together with the manifold.

FIG. 11 is a schematic enlarged view of the details of the cover carriage shown in the cradle position in solid lines and in the raised position in dotted lines, together with the cover and manifold.

FIG. 12 is a schematic perspective view of the bunker sealing system showing the bunker silo, the cover handling equipment and the water or other liquid handling equipment with the cover carriage and cover in a partially uncovered condition.

### DETAILED DESCRIPTION OF THE PREFERRED EMBODIMENT

Referring to the attached Figures, the present invention a bunker sealing system shown generally as 100 includes the following major sections, namely bunker silo 102, covering handling equipment 200 and liquid handling equipment 300.

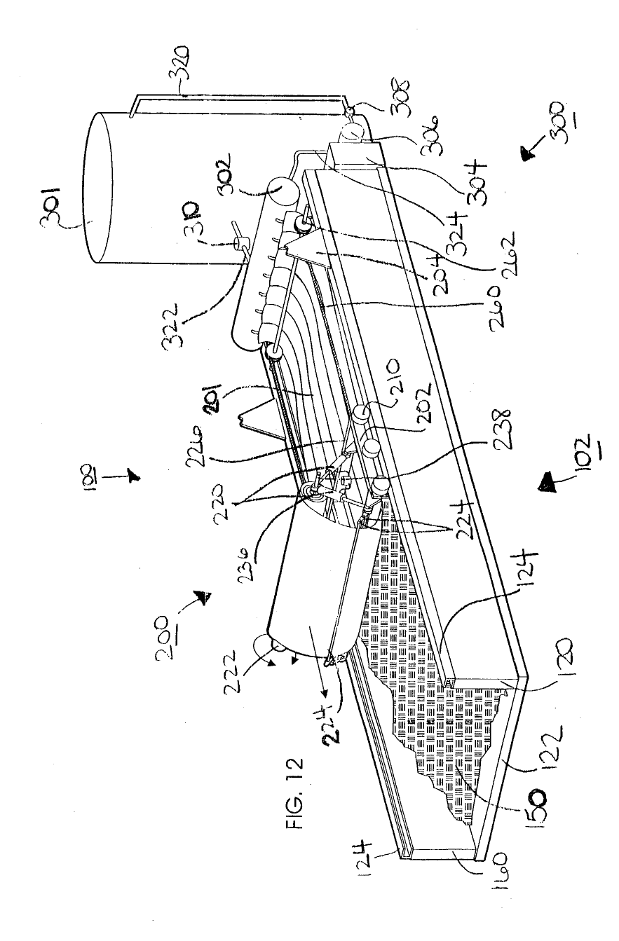

Referring firstly to FIG. 12, bunker silo 102 includes the following major components, namely, bunker walls 120 each having a top rail 124 mounted thereon and also a bunker floor 122. Bunker silo 102 houses silage 150 which is compacted into place using traditional methods well known in the art for filling of bunker silos.

Cover handling equipment 200 includes cover 201, a cover carriage 202 which includes carriage frame 226, carriage wheels 210, cover spool 236, spool shaft 238, spool shaft drive motor 222, guide rollers 224 and hydraulic cylinders 220. In addition, cover handling equipment 200 also includes carriage cradles 204, cables 260, down turn pulleys 262 and cable take up drum 264 as shown in FIG. 4.

Liquid handling equipment 300 includes main storage tank 301, manifold 302 and surge tank 304. Interconnecting and controlling the liquid flow between these three containers, includes outlet pipe 322 communicating with outlet valve 310, surge pipe 324, communicating with control valve 312, pump 306, inlet pipe 320, communicating with inlet valve 308.

Cover

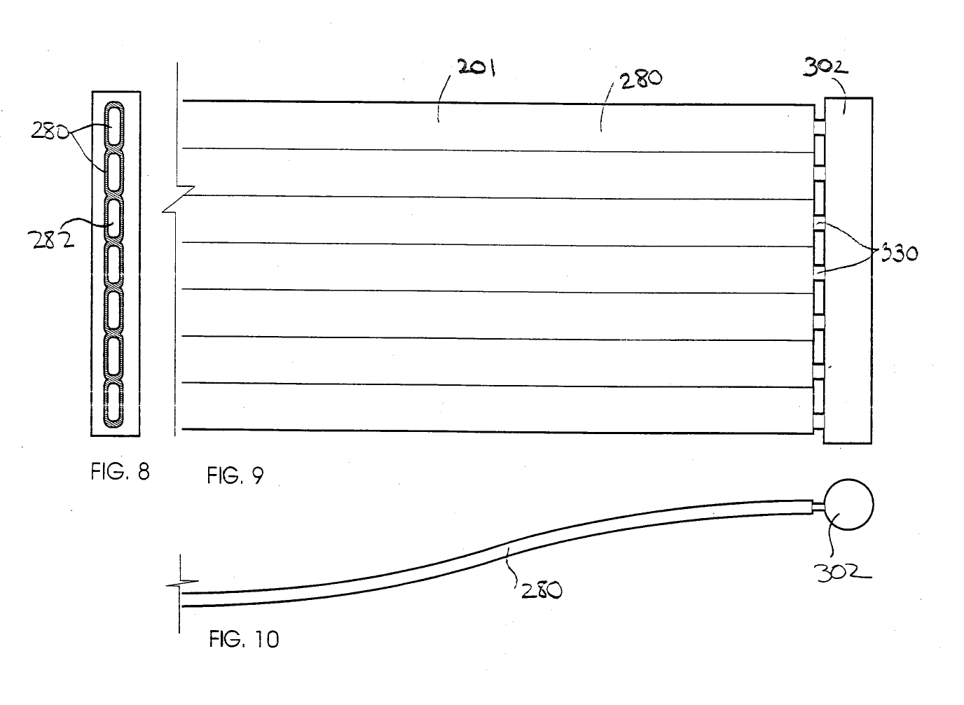

Cover 201 can be constructed in many different configurations that are currently known in the art, however by way of example only the present application includes two different examples. Cover 201 could be made of a number of bladder sections 280 as shown in FIGS. 8, 9 and 10. Each bladder section 280 defining a liquid conduit 282 through which liquid can communicate along the length of each bladder section 280. Manifold 302 includes manifold connections 330 which communicates liquid into each liquid conduit 282 defined by each bladder section 280. Each bladder section can either be manufactured individually and then connected together and/or manufactured as a single continuous webbing.

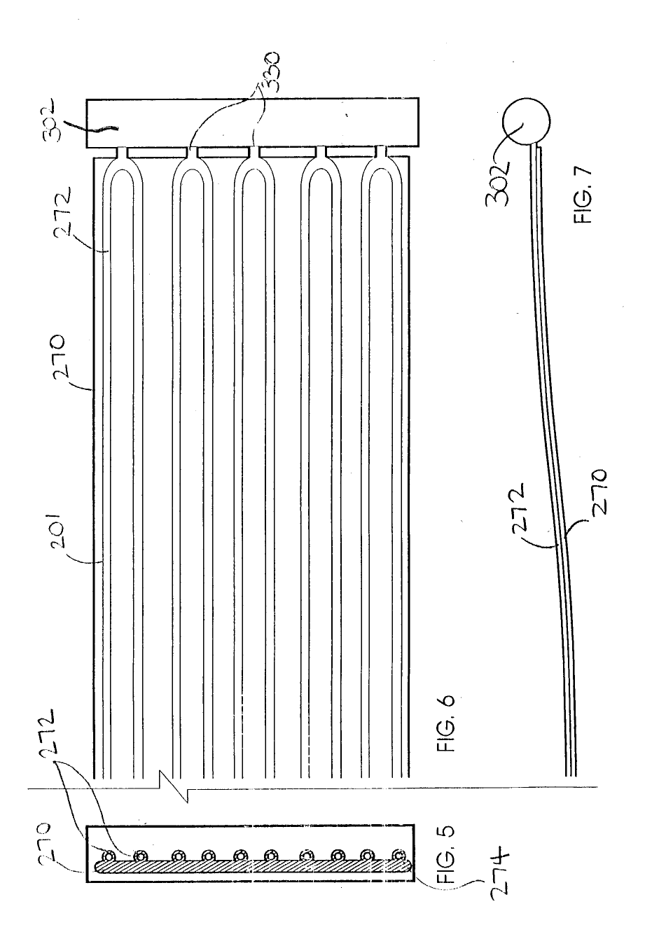

The presently preferred alternate embodiment of cover 201 is shown in FIGS. 5, 6 and 7 and includes a moisture barrier sheet 270 having attached on one side thereof cover tubing 272 running along the length of moisture barrier sheet 270. Moisture barrier sheet 270 can be made of any material presently known in the art including various plastics including vinyl, polypropylene, polyethylene and/or reinforced vinyl, polypropylene, polyethylene and like materials. Cover tubing 272 can also be manufactured of various plastics and/or rubbers and/or various reinforced rubbers or plastics which are conventionally used for the manufacture of tubing carrying relatively low pressure liquid. Each cover tubing 272 communicates with manifold 302 via manifold connections 330.

Cover tubing 272 is securely attached to moisture barrier sheet 270 by methods known in the art and each cover tubing 272 defines there through a liquid conduit 274 for communicating liquid between cover tubing 272 and manifold 302.

Not shown in the diagrams cover 201 may be made of any suitable thickness and suitable material for the conditions. In particular cover 201 may be designed to hold a greater amount of liquid for not only holding the cover in place over the silage but also for aiding in compacting and settling the silage under the cover. It is for example possible that a cover providing for one foot of liquid depth or more be used to be placed over the silage. The weight of this amount of liquid would help settle and compact the silage and ensure a tight seal. Modifications to the equipment may be required including the ability to extract large volumes of liquid from the cover to help in its removal.

The liquid used in the cover may be water, or other solutions which resist or lower the freezing temperature of then water. The liquid used to fill the cover may be some type of alcohol, glycol, or solutions which may or may not contain water.

In Use

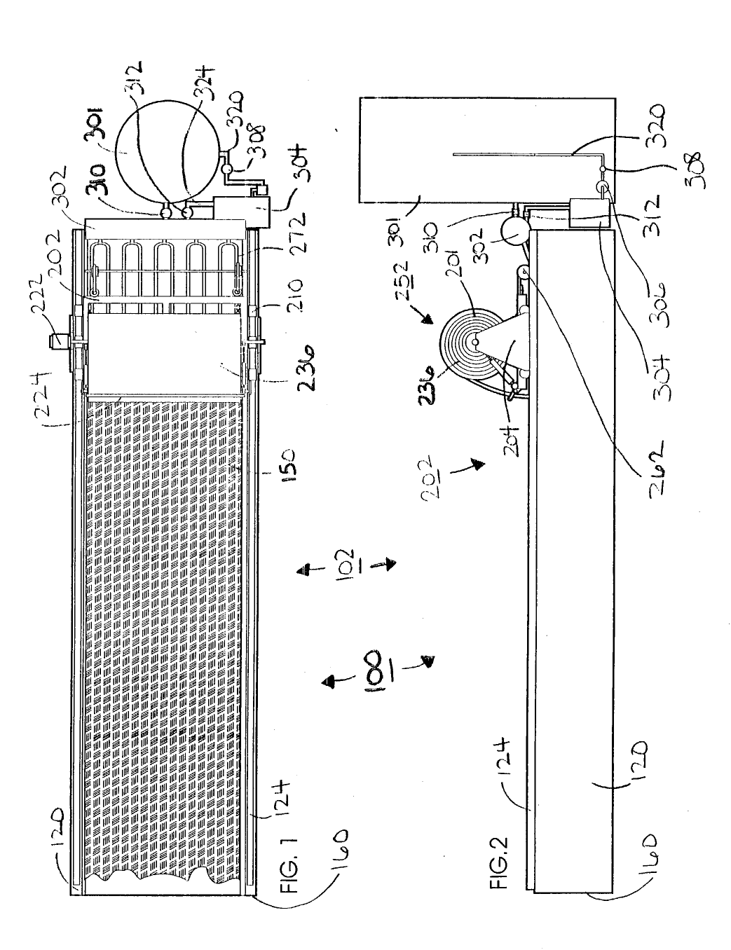

Bunker sealing system described above and as depicted in FIGS. 1 through 12 is preferably used as follows.

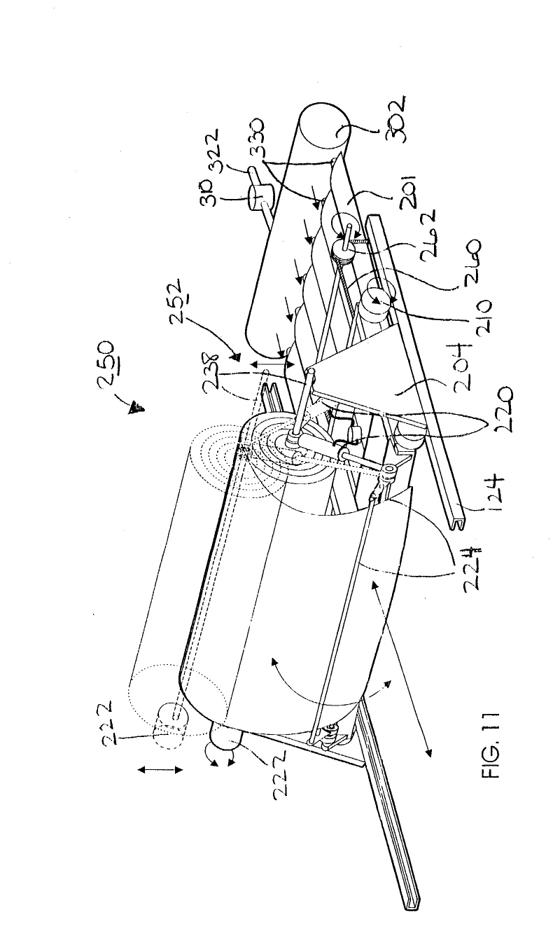

Referring to FIGS. 1 and 2, silage 150 is loaded into bunker silo 102 in a traditional manner until bunker silo 102 is filled to capacity. During filling of silage 150 into bunker silo 102, cover carriage 202 is parked on the carriage cradles 204 in the rearward portion of bunker silo 102 closest to the main storage tank 301. Cover carriage 202 in this position does not interfere with the filling of bunker silo 102 with silage 150. Cover spool 236 rests on carriage cradles 204 in the cradle position 252 as shown in FIG. 2 and also in FIG. 11. Cover 201 is spooled onto cover spool 236 as shown in FIG. 2 and a drive motor 222 controls the rotation of the spool shaft 238 and therefore the pay out of cover 201 off of cover spool 236. Once bunker silo 102 has been filled with silage 150, cover 201 can be placed over silage 150 as will now be explained.

Referring at this time to FIG. 11, cover spool 236 can be raised and lowered from the cradle position 252 to a raised position 250 by actuating hydraulic cylinders 220 as shown in FIG. 11. With cover spool 236 in the spool raised position 250 as shown in the dotted outlines in FIG. 11, outlet valve 310 is opened for communicating liquid from main storage tank 301 to outlet pipe 322, thereby filling manifold 302 with liquid. The liquid head created in storage tank 301 creates liquid pressure within manifold 302 which communicates with cover 201 via manifold connections 330. The liquid entering into cover 201 via manifold connections 330 fills bladder sections 280 as shown in FIGS. 8, 9 and 10 and/or cover tubing 272 as shown in FIGS. 5, 6 and 7 and this pressure would naturally tend to urge cover carriage 202 forwardly along the length of bunker silo 102. Simultaneously cover 201 would unspool from cover spool 236 thereby covering over silage 150 stored in bunker silo 102. Note that cable 260 and downturn pulley 262 would be loose and drive motor 222 of spool shaft 238 may aid in the unspooling of cover 201 if necessary. In addition top rail 124 mounted on bunker walls 120 may have a slight downward slope so that cover carriage 202 would naturally tend to move forward and away from carriage cradle 204 thereby unspooling cover spool 236. Depending upon the location of cover carriage 202, the height of spool shaft 238 can be controlled with hydraulic cylinders 220 and the spooling and unspooling of cover 201 on cover spool 236 can additionally be controlled with spool shaft drive motor 222 as well as guide rollers 224.

Although not shown it may be possible that guide rollers 224 would be linked together with drive motor 222 which drives spool shaft 238 for aiding in the spooling and unspooling of cover 201 off of cover spool 236. In addition, the ability to raise and lower spool shaft 238 using hydraulic cylinders 220, enables one to optimize the angle at which the cover 201 is being spooled or unspooled. In this manner one can always maintain the optimum angle of the forces acting on cover 201.

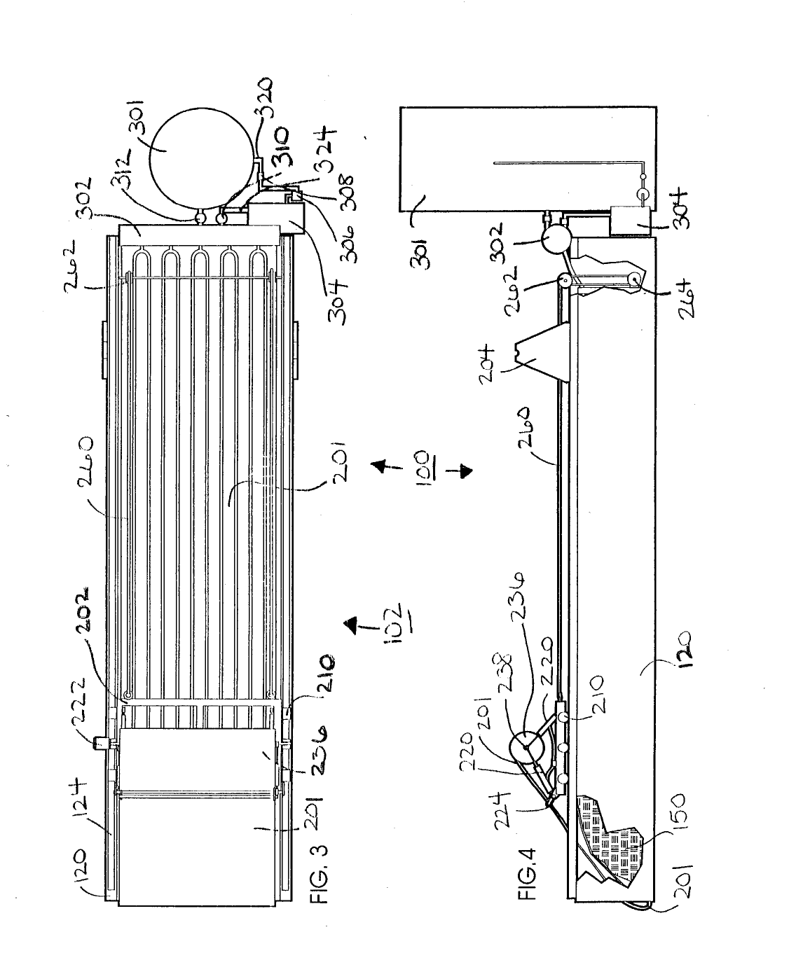

When bunker silo 102 is completely filled with silage 150 cover carriage 202 is rolled out to almost the front end 160 of bunker silo 102 as shown in FIGS. 3 and 4. In this position cover 201 covers over and seals off silage 150 from air and moisture as shown in FIG. 4.

In order to uncover the feeding face or that area of the silage closest to the front end 160, cover 201 would be spooled onto cover spool 236 using drive motor 222 and in this manner only the front face or the feeding face of silage 150 needs to be uncovered with the balance of the bunker silo 102 being maintained in its covered position. During the uncovering process for example, outlet valve 310 would be closed and control valve 312 would be opened to allow liquid to drain from manifold 302 which in turn would naturally drain the liquid out of cover 201 as the end of cover 201 is being spooled onto cover spool 236. Control valve 312 would be opened for the liquid to flow into surge tank 304. Cover 201 is shown in a partially uncovered position in FIG. 12.

Bunker silo 102 will be emptied of silage 150 over time and as the feeding front or the front face of silage 150 moves rearwardly towards main storage tank 301, cover carriage 202 will also have to be wheeled and/or rolled backwardly toward main storage tank 301. This is accomplished by rotating take up drum 264 as shown in FIG. 4 which in turn pulls cable 260 over top of downturn pulley 262. Cable 260 is attached at one end to carriage frame 226 and at the other end to take up drum 264. In this manner cover carriage 202 can be wheeled along top rail 124 to any desired position along bunker silo 102.

Liquid that accumulates within surge tank 304, can be pumped back into main storage tank 301 using pump 306 and inlet valve 308.

Kindly note that the diagrams shown are schematic in nature and the piping and location of the manifold and the valves etc, may not be exactly as shown however, the drawings do convey how the system would function and operate.

The construction of cover 201 is dictated by cost, convenience, and durability considerations and at this time it is believed that cover 201 would preferably be constructed int two parts namely, moisture barrier sheet 270 and cover tubing 272 securely attached to the moisture barrier sheet 270.

Those skilled in the art will of course realize that cover 201 is so placed onto silage 150 so as to minimize the penetration of air and water into silage 150. In addition by sealing off the feeding face when not in use, again the penetration of air and moisture into silage 150 is minimized.

It should be apparent to persons skilled in the arts that various modifications and adaptation of this structure described above are possible without departure from the spirit of the invention the scope of which defined in the appended claim.

I claim:

1) A bunker sealing system for use with a horizontal style bunker, said bunker sealing system comprising:
a) a bunker silo for storing silage therein;
b) a cover for selectively covering and sealing silage; and
b) a means for selectively sealing silage such that the penetration of water and air into silage is minimized.

2) The bunker sealing system claimed in claim 1 wherein said sealing means including a liquid means for selectively filling and removing liquid from said cover for weighing down said cover with liquid thereby ensuring said cover remains on said silage and maximizes sealing of said cover.

3) The bunker sealing system claimed in claim 2 wherein said sealing means including a cover comprised of liquid tillable bladders.

4) The bunker sealing system claimed in claim 2 wherein said sealing means including a cover comprised of a moisture barrier sheet and a network of cover tubing attached to said moisture barrier, wherein said tubing for filling and evacuating with liquid for weighing down said cover with liquid thereby ensuring said cover remains on said silage and maximizes sealing of said cover.

5) The bunker sealing system claimed in claim 2 wherein said sealing means includes cover handling equipment including a means for spooling and unspooling said cover onto and off of a cover spool.

6) The bunker sealing system claimed in claim 5 wherein said spool means includes a carriage means for moving said spool means longitudinally along the length of the bunker silo and supporting said spool means.

7) The bunker sealing system claimed in claim 6 wherein said carriage means includes a cover carriage includes wheels cooperatively rolling along top rails mounted on top of bunker walls, such that said carriage spans between two bunker walls and is rollably moveable longitudinally along said walls.

8) The bunker sealing system claimed in claim 7 wherein said spool means includes means for raising and lowering said spool.

9) The bunker sealing system claimed in claim 2 wherein said spool means includes rotating means for applying rotational forces to said cover spool for spooling and unspooling.

10) The bunker sealing system claimed in claim 6 wherein said carriage means includes a drive means for moving said carriage longitudinally along said bunker silo.

11) The bunker sealing system claimed in claim 2 wherein said liquid means includes water handling equipment including a manifold for selectively communicating liquid to and from said cover.

12) The bunker sealing system claimed in claim 11 wherein said liquid means further includes a main storage tank for selectively communicating liquid to said manifold under a head of liquid pressure.

13) The bunker sealing system claimed in claim 12 wherein said liquid means includes a surge tank for receiving liquid from said cover and communicating said liquid back to said storage tank.

14) The bunker sealing system claimed in claim 13 wherein said liquid means includes a liquid pumping system and valves for controlling movement of liquid between the storage tank, manifold and surge tank.

15) The bunker sealing system claimed in claim 5 wherein said spooling means and carriage means cooperates with said liquid means such that filling said cover with liquid aids in unspooling said cover off of said cover spool.
